(19) United States
(12) Patent Application Publication
(10) Pub. No.: US 2008/0223012 A1
(43) Pub. Date: Sep. 18, 2008

(54) Cordless electric mower fail-safe charge lockout

(75) Inventors: Richard Rosa, Kingston (CA); David M. Shaver, Brockville (CA); David Topping, Brockville (CA)

Correspondence Address: KRAMER & AMADO, P.C., 1725 DUKE STREET, SUITE 240, ALEXANDRIA, VA, 22314, US

(73) Assignee: BLACK & DECKER, INC., TOWSON, MD (US)

(21) Appl. No.: 11/717,088

(22) Filed: Mar. 13, 2007

(51) Int. Cl. A01D 69/00

(52) U.S. Cl. 56/11.9

(57) ABSTRACT

A cordless mower, including a start-up key that must be removed to charge a battery. The start-up key must be inserted to operate the motor, and can be moved to a different position or removed to interrupt the motor. The mower cannot be operated when the switch is not actuated. Some embodiments include a lockout relay that disables charging of the battery when a charge on the battery exceeds a predetermined threshold. Thus, the cordless mower can be safely charged by removing the start-up key and inserting a charge connector that cannot otherwise be inserted. The cordless mower can be safely powered by inserting the start-up key and moving it into an operation position, and then closing the switch to run the mower. The cordless mower can be safely shut off in an emergency by removing the start-up key or moving it to a safety position.

### BACKGROUND OF THE INVENTION

### 1. Field of the Invention

This invention relates generally to mechanisms and methods for powering a cordless electric lawnmower.

### SUMMARY OF THE INVENTION

Devices for cutting blades of grass such as those on a lawn are known. These devices are often referred to as mowers. Some mowers are powered by gas. Other mowers are powered by different means. For example, some lawn mowers are powered by electricity.

Some electrical power mowers have an electrical power cord that plugs into an electrical outlet. Other electric power mowers are cordless. Cordless power motors typically include a battery that must be charged periodically.

Lawn mowers are potentially dangerous machines if used incorrectly. Serious injuries can occur when a lawn mower is operating at an inappropriate time. Thus, it is desirable for a lawn mower to include a feature that causes the mower to stop functioning if an operating switch associated with the mower fails.

An example of a failure of the operating switch of a lawn mower is when the operating switch of a lawn mower gets stuck in the on position. Another example is when the operator of the mower uses tape or some other substance to secure the operating switch for the mower in an on position. It is desirable in such circumstances to include a feature that prevents the lawn mower from operating.

Some electric mowers include a switch as described above. However, it is undesirable for the mower to be operational by turning a switch to an on position while a battery provided with the electric mower is charging. Thus, in a cordless electric lawn mower including a switch, it is desirable that, when the battery of the mower is charging, the mower cannot be operated by actuating the switch.

In some cordless electric lawn mowers, a separate on-off switch is included, and the operator of the mower is expected to place the on-off switch in the off position when charging a battery provided with the mower. However, despite this requirement, some such mowers will operate while charging their battery so long as the switch is left in the on position, either intentionally or unintentionally.

Thus, it is desirable in a cordless electric lawn mower including a switch and a chargeable battery that the mower will not operate when the battery is charging, even if the switch is in the on position. Further, it is desirable that this functionality be intrinsic to the design of the lawn mower, and not require action by an owner or operator of the mower.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

In light of the present need for a fail-safe charge lock out assembly that prevents operation of the mower while a rechargeable battery within the mower is being charged, and a removable key that must be inserted and turned to complete a path in order to operate the mower, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

### BRIEF DESCRIPTION OF THE DRAWINGS

In order to better understand various exemplary embodiments, reference is made to the accompanying drawings, wherein:

FIG. 1 is an electrical schematic diagram of an exemplary embodiment of a fail-safe charge lockout;

FIG. 2 is an electrical schematic diagram of another exemplary embodiment of a fail-safe charge lockout;

FIG. 3 is a perspective view of an exemplary fail-safe charge lockout with an exemplary start-up key shown in an installed position;

FIG. 4 is a perspective cut away view of the exemplary fail-safe charge lockout of FIG. 3 with an exemplary key removed;

FIG. 5 is a perspective cut away view of the exemplary fail-safe charge lockout of FIG. 3 with the exemplary key inserted;

FIG. 6 is a perspective cut away view of the exemplary fail-safe charge lockout of FIG. 3 with the exemplary key inserted and rotated;

FIG. 7 is a fragmented perspective cut away view corresponding to FIG. 4;

FIG. 8 is a fragmented perspective cut away view corresponding to FIG. 5;

FIG. 9 is a fragmented perspective cut away view corresponding to FIG. 6; and

FIG. 10 is a fragmented perspective cut away view of an exemplary embodiment of a fail-safe charge lockout with the exemplary key in an exemplary on position.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

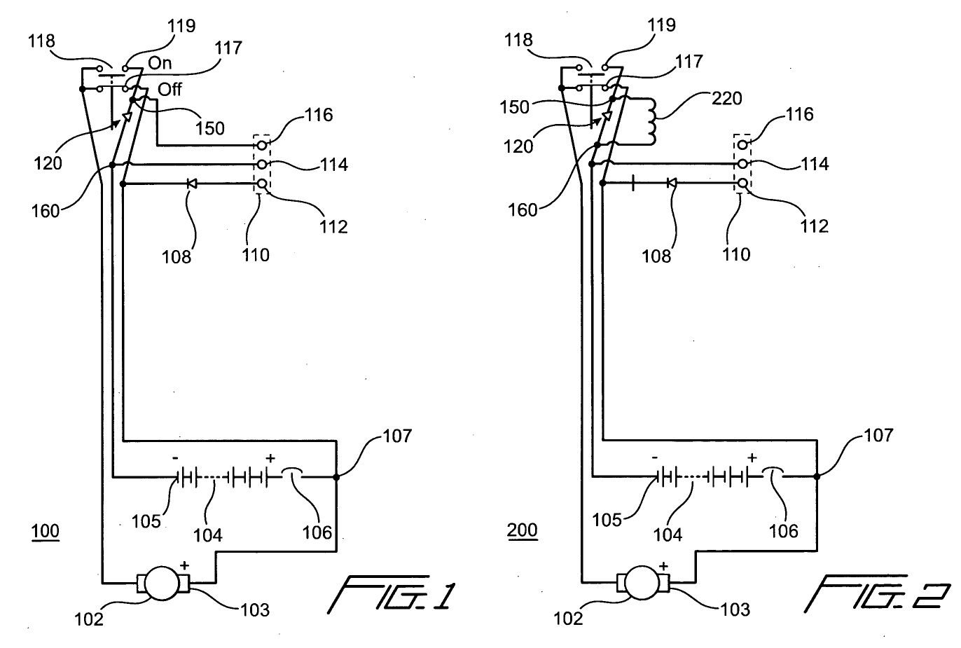

FIG. 1 is an electrical schematic diagram of a fail-safe charge lockout 100. The lockout 100 includes a motor 102, a battery 104, a breaker 106, a diode 108, a charge connector 110, a switch 118 and a start-up key 120.

In FIG. 1, the charge connector 110 includes a charge lockout terminal 116, a common terminal 114 and a positive charge terminal 112. The positive charge terminal 112 is connected electrically through the diode 108 to a positive terminal 103 of the motor 102, a positive terminal 107 of the breaker 106, and an off terminal 117 of the switch 118.

The common terminal 114 of the charge connector 110 is connected to a negative terminal 105 of the battery 104. The common terminal 114 of the charge connector 110 is also connected to an on terminal 119 of the switch 118 by way of the start-up key 120. Thus, the negative terminal 105 of the battery 104 is also connected to the on terminal 119 of the switch 118. The charge lockout terminal 116 of the charge connector 110 is connected to the on terminal 119 of the switch 118 without the start-up key 120 intervening.

The foregoing structure enables the mower to operate only when the key is inserted in the mower and rotated to complete an electrical path. Likewise, a user is prevented from operating the mower while the mower is being charged. When a start-up key is removed, the mower is shut off. Further, a battery in a cordless electric power mower cannot be charged while a key is rotated to actuate operation of the mower. When a start-up key is rotated into an on position, the charge connector cannot be inserted to charge the mower battery. Similarly, when the charge connector is inserted to charge the mower battery, the start-up key cannot be rotated into the on position.

If the switch 118 gets stuck in an on position, and the start-up key 120 is removed, then the voltage drop between the positive charge terminal 112 with respect to the common terminal 114 of the charge connector 110 will be the full value of the positive charge on the positive terminal 103 of the motor 102.

When the voltage of the positive charge terminal 112 with respect to the common terminal 114 of the charge connector 110 is equal to the positive voltage on the positive terminal 103 of the motor 102, a charger provided with the cordless electric lawn mower is prevented from charging even if the charger of the cordless electric lawnmower is otherwise properly connected to deliver a charge.

Under normal charging conditions the exemplary start-up key 120 is removed. Under these conditions, the charge lockout terminal 116 is floating. In other embodiments, under normal charging conditions, the charge lockout terminal 116 is pulled low in the charger.

When a user actuates the switch 118 at a time when the charger of the cordless electric power mower is plugged in, the charge current supplied to the battery in the cordless electric power mower is interrupted.

During normal operation, the charge lockout terminal 116 is open. However, during a failure of the switch 118, the voltage on charge lockout terminal 116 could be as large as the voltage across the battery 104. Thus, the voltage of the charge lockout terminal 116 with respect to ground in monitored and compared to a predetermined threshold voltage. The predetermined threshold voltage is equal to or less than the voltage of the battery 104. When the voltage monitored on the charge lockout terminal 116 with respect to ground exceeds the predetermined threshold, the process of charging a rechargeable battery in a cordless electric power mower is interrupted.

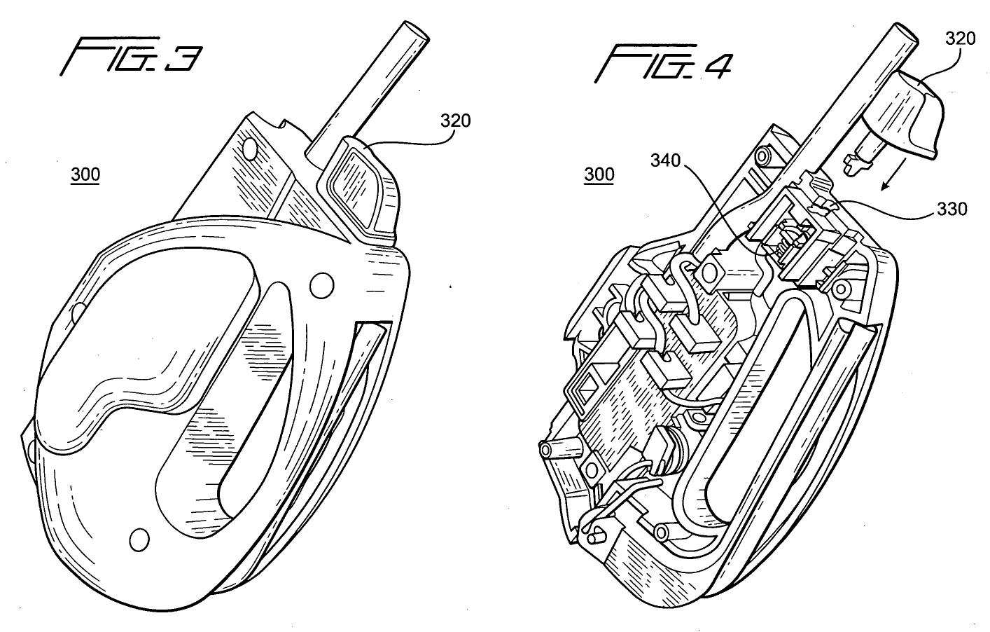

FIG. 2 is an electrical schematic diagram of another exemplary embodiment of a fail-safe charge lockout 200. The fail-safe charge lockout 200 corresponds to the fail-safe charge lockout 100 depicted in FIG. 1 in many respects. Some differences between the fail-safe charge lockout 200 and the fail-safe charge lockout 100 include the following.

With the fail-safe charge lockout 200, a separate control is included in a mower switch enclosure. A separate control monitors the condition of contacts of the exemplary switch 118, including off terminal 117 and on terminal 119. Charging of a charger provided with the cordless electric lawnmower is disabled when the switch 118 is locked in an on position.

In some embodiments, a lockout relay 220 is provided. As depicted in FIG. 2, the lockout relay 220 connects opposing sides of the exemplary switch 120. The lockout relay 220 relays a voltage equivalent to the voltage provided by the exemplary battery 104. It should be apparent to one having an ordinary level of skill in the art that, in other embodiments, the functions of monitoring and controlling the circuit depicted in FIG. 2 are performed by other electronic means.

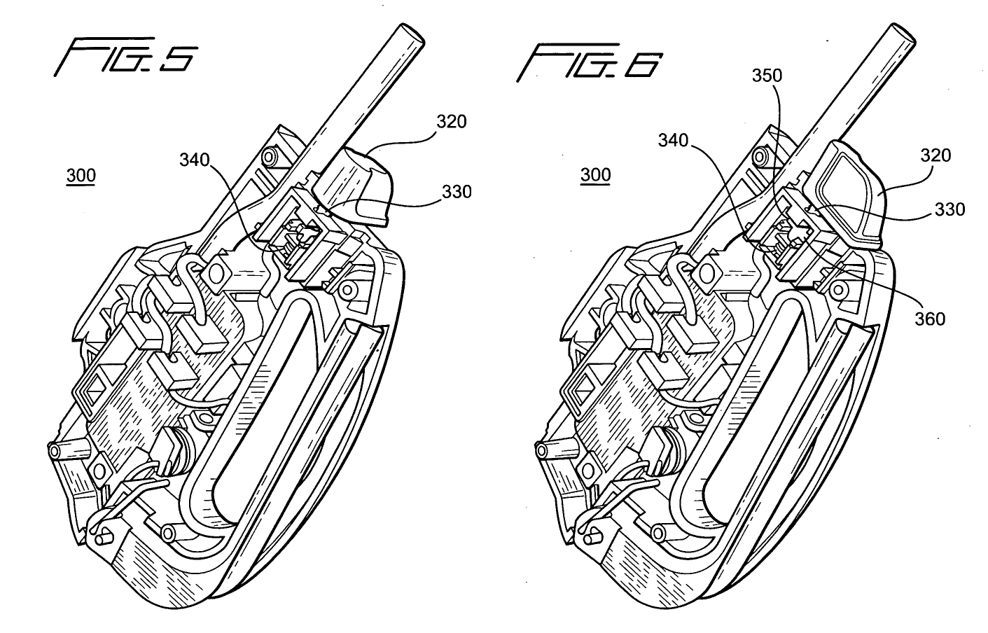

FIGS. 3-10 show a variety of environmental perspective views of a fail-safe charge lockout 300. The fail-safe charge lockout 300 includes a start-up key 320. The start-up key 320 corresponds to a physical implementation of the start-up key 120 depicted in FIGS. 1 and 2. FIG. 3 is a perspective view of a fail-safe charge lockout 300 with a start-up key 320 shown in an installed position.

Referring to FIG. 4, the start-up key 320 is removed from a keyhole 330 in the fail-safe charge lockout 300. A biasing spring 340 is extended in the fail-safe charge lockout 300 when the start-up key 320 is removed.

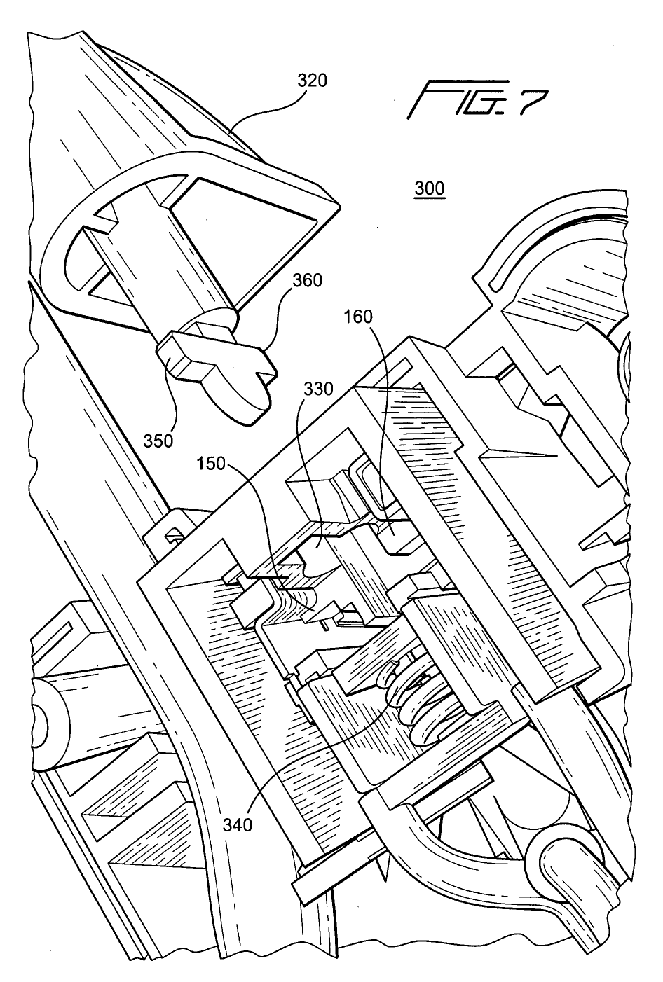

FIG. 5 is a perspective cut away view of the fail-safe charge lockout 300 with the tart-up key 320 inserted in the keyhole 330. Thus, in FIG. 5 the biasing spring 340 is compressed by the insertion of the start-up key 320 in the keyhole 330. In this manner, the biasing spring 340 exerts pressure against the start-up key 320 when the start-up key 320 is inserted in the keyhole 330.

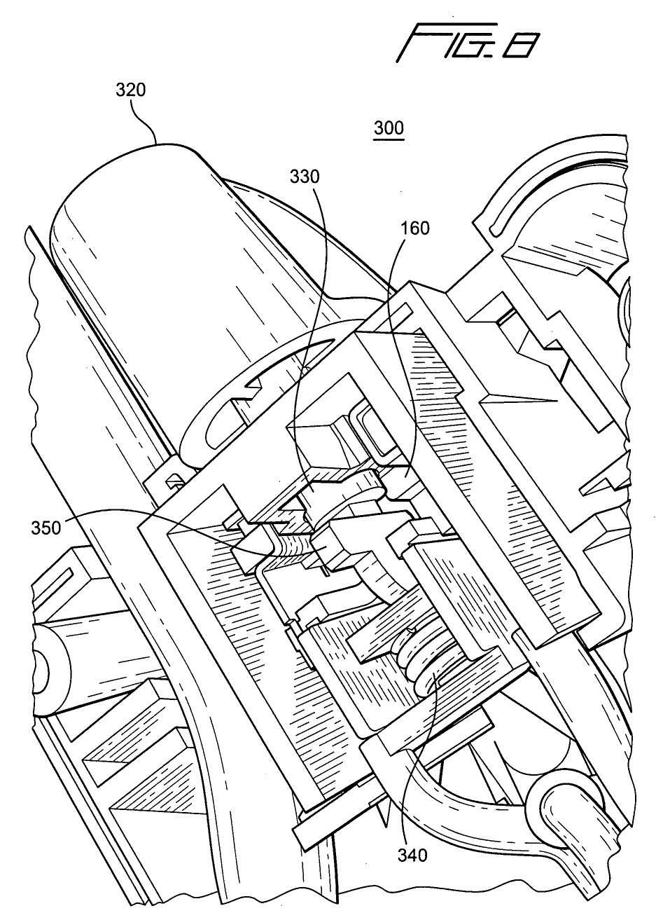

FIG. 6 is a perspective cut away view of the fail-safe charge lockout 300 with the start-up key 320 inserted in the keyhole 330 and rotated. Specifically, as compared to FIG. 5, the start-up key 320 is rotated clockwise 90 degrees in FIG. 6. This illustrates an intermediate temporary position en route to an on position. Thus, in the process of rotating, edges 350 and 360 of the start-up key 320 also rotate to make electrical contact between two terminals in the fail-safe charge lockout 300 corresponding to nodes 150 and 160 in FIGS. 1 and 2.

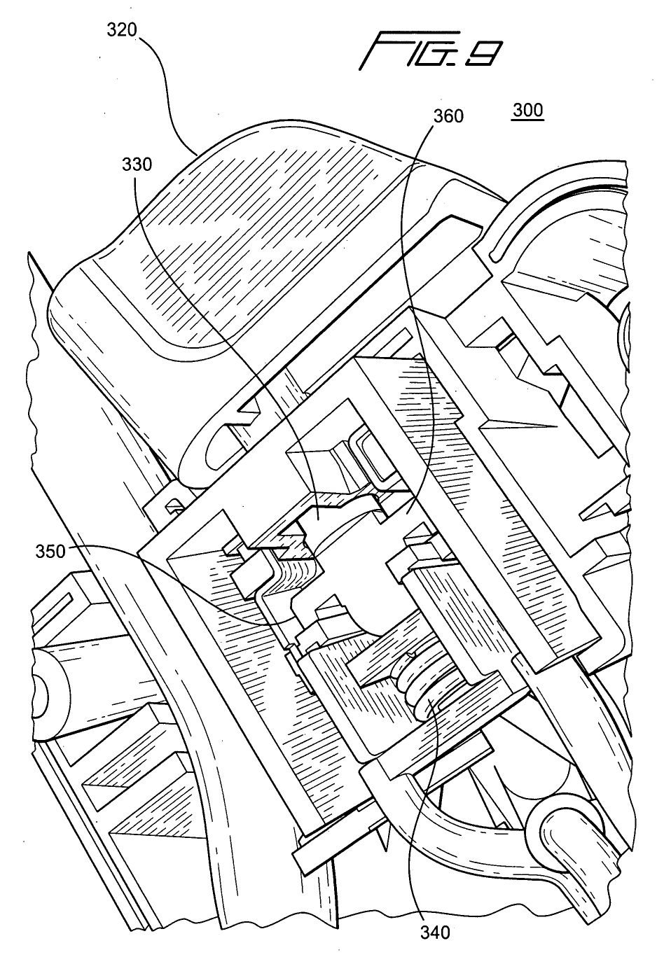

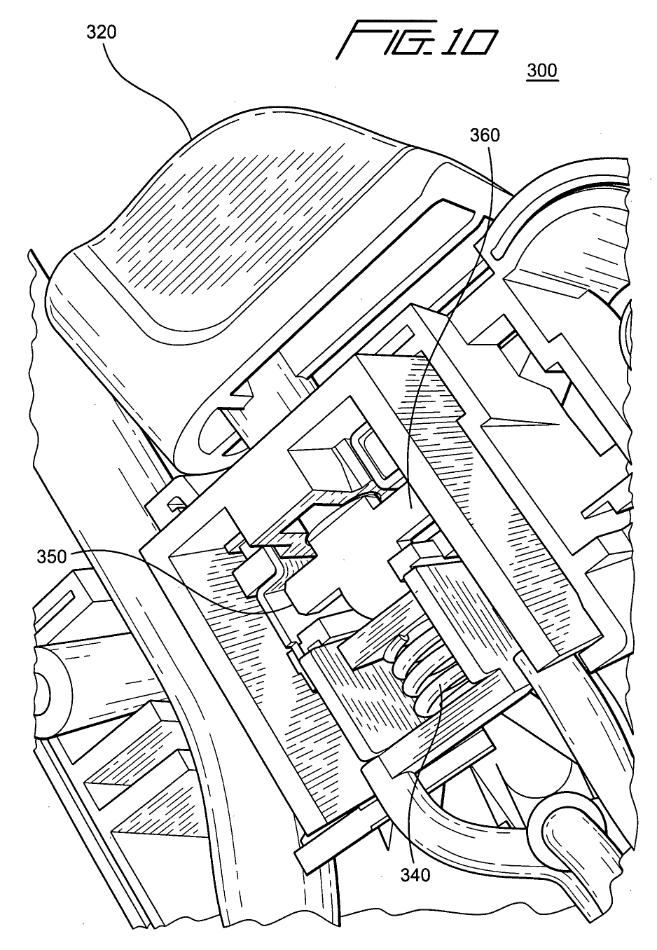

FIG. 7 is a fragmented perspective cut away view depicting the fail-safe charge lockout 300, the start-up key 320, the keyhole 330, the extended biasing spring 340, and the terminals corresponding to nodes 150 and 160 from a different angle, and in greater detail than FIG. 4. Similarly, FIG. 8 is a fragmented perspective cut away view depicting the fail-safe charge lockout 300, the start-up key 320, the keyhole 330, the compressed biasing spring 340, and other features discussed above, from a different angle, and in greater detail in FIG. 5. FIG. 9 is a fragmented perspective cut away view depicting the fail-safe charge lockout 300, the start-up key 320, the keyhole 330, the compressed biasing spring 340, and the edges 350 and 360 of the start-up key 320 rotated to align with nodes 150 and 160, en route to an on position, as described above in greater detail.

FIG. 10 is a fragmented perspective cut away view of an embodiment of a fail-safe charge lockout 300. Specifically, the start-up key 320 is in an on position. The on position results from the force of the biasing spring 340 biasing the start-up key 320 against the electrical terminals representing electrical nodes 150 and 160.

In the manner described above, a cordless electric power mower is provided with a key that enables the mower to operate only when the key is inserted in the mower and rotated to complete an electrical path. Likewise, a fail-safe charge lockout assembly is provided including an internal spring that biases the key against internal contacts. Similarly, a fail-safe charge lockout assembly is provided with a charger lockout or a relay lockout that prevents a user from operating the mower while the mower is being charged. Likewise, a removable start-up key is electrically connected into an electric path such that, when the key is removed, the mower is shut off. Further, an exemplary electrical circuit is provided with mechanical components such that a battery in a cordless electric power mower cannot be charged while a key is rotated to actuate operation of the mower. When a start-up key is rotated into a position to actuate the mower, interchangeably referred to herein as an “on” position, the charge connector cannot be inserted to charge the mower battery. Likewise, when the charge connector is inserted to charge the mower battery, a start-up key cannot be rotated into an actuation or “on” position.

Although the various exemplary embodiments above have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A cordless electric mower, comprising:
a motor;
a rechargeable battery that powers the motor via an electrical connection;
a charging mechanism that connects the rechargeable battery to an electrical power source when charging the rechargeable battery;
a switch that enables the motor to operate by completing an electrical circuit when actuated; and
a fail-safe charge lockout including a start-up key that electrically connects the rechargeable battery and the switch when actuated,
wherein the start-up key must be removed to charge the rechargeable battery.

2. The cordless mower according to claim 1, further comprising a charge connector including a charge lockout terminal, a common terminal, and a positive charge terminal.

3. The cordless mower according to claim 2, wherein the charge lockout terminal is electrically connected to an on terminal of the switch, the common terminal is electrically connected to a negative terminal of the rechargeable battery, and the positive charge terminal is electrically connected to an off terminal of the switch and a positive terminal of the rechargeable battery.

4. The cordless mower according to claim 3, wherein the start-up key is electrically connected between the charge lockout terminal and the common terminal.

5. The cordless mower according to claim 1, further comprising a keyhole through which the start-up key is inserted to the first position.

6. The cordless mower according to claim 1, wherein the start-up key is rotated to move from the first position to the second position.

7. The cordless mower according to claim 1, wherein ends of the start-up key make electrical contacts to complete the electrical circuit when the start-up key is in the second position.

8. The cordless mower according to claim 7, further comprising a biasing device that applies a second physical force to the start-up key to hold the start-up key in the on position when the first physical force is not applied.

9. The cordless mower according to claim 1, wherein the battery cannot be charged when the switch is actuated.

10. The cordless mower according to claim 1, wherein the start-up key must be inserted into an on position to operate the motor.

11. The cordless mower according to claim 1, wherein the start-up key can be removed to interrupt the operation of the motor.

12. A cordless electric mower, comprising:
a motor;
a rechargeable battery that powers the motor via an electrical connection;
a charging mechanism that connects the rechargeable battery to an electrical power source when charging the rechargeable battery;
a switch that enables the motor to operate by completing an electrical circuit when actuated;
a lockout relay; and
a fail-safe charge lockout including a start-up key that electrically connects the rechargeable battery and the switch when actuated,
wherein the start-up key must be removed to charge the rechargeable battery.

13. The cordless mower according to claim 12, further comprising a charge connector including a common terminal and a positive charge terminal.

14. The cordless mower according to claim 13, wherein the common terminal is electrically connected to a negative terminal of the rechargeable battery and the positive charge terminal is electrically connected to an off terminal of the switch and a positive terminal of the rechargeable battery.

15. The cordless mower according to claim 14, wherein the start-up key is electrically connected between the common terminal and an on terminal of the switch.

16. The cordless mower according to claim 15, wherein the lockout relay is electrically connected between the common terminal and an on terminal of the switch.

17. The cordless mower according to claim 12, further comprising a keyhole through which the start-up key is inserted to the first position.

18. The cordless mower according to claim 12, wherein inserting the start-up key to the on position includes rotating the start-up key.

19. The cordless mower according to claim 12, wherein ends of the start-up key make electrical contacts to complete the electrical circuit when the start-up key is in the second position.

20. The cordless mower according to claim 19, further comprising a biasing device that applies a physical force to the start-up key to hold the start-up key in the on position.

21. The cordless mower according to claim 12, wherein the battery cannot be charged when the switch is actuated.

22. The cordless mower according to claim 12, wherein the start-up key must be inserted into an on position to operate the motor.

23. The cordless mower according to claim 12, wherein the start-up key can be removed to interrupt the operation of the motor.

24. The cordless mower according to claim 12, wherein the lockout relay disables charging of the rechargeable battery when a voltage to which the rechargeable battery has been charged exceeds a predetermined threshold.

25. A method of safely powering and safely charging a cordless mower, comprising:
removing a start-up key and inserting a charge connector to charge a rechargeable battery of the cordless mower;
inserting the start-up key and closing the switch to operate the cordless mower; and
moving the start-up key to a safety position to shut off a motor of the mower, wherein
the start-up key electrically connects the rechargeable battery and the switch when actuated,
the rechargeable battery cannot be charged when the switch is closed or when the start-up key is inserted, and
the motor of the mower cannot be operated when the switch is open or when the start-up key is not inserted.
